(19) United States
(12) Patent Application Publication
(10) Pub. No.: US 2026/0099811 A1
(43) Pub. Date: Apr. 9, 2026

(54) ORDER FULFILMENT METHOD, AND ASSEMBLY CONFIGURED TO IMPLEMENT THE METHOD

(71) Applicant: Exotec Product France, CROIX (FR)

(72) Inventor: Romain MOULIN, LILLE (FR)

(73) Assignee: Exotec Product France, CROIX (FR)

(21) Appl. No.: 19/351,502

(22) Filed: Oct. 7, 2025

(30) Foreign Application Priority Data
Oct. 7, 2024 (FR) FR2410784

(51) Int. Cl. G06Q 10/087; B65G 1/04

(52) U.S. Cl. CPC G06Q 10/08741; B65G 1/0492

(57) ABSTRACT

An order fulfilment method implemented in an automated storage and retrieval system, the method includes loading each of the stocking boxes onto a container to form storage assemblies, transporting the storage assemblies to storage spaces in the storage structure, fulfilling orders at the at least one order fulfilment station, including, for all or some of the orders, picking at least one item from at least one of the storage assemblies and placing the at least one item into an order box, at least one stocking box being emptied, the stocking box emptied of the at least one item is used as the order box for at least one of the orders in.

The present disclosure relates to an order fulfilment method. The present disclosure also relates to an assembly comprising a storage and retrieval system and boxes containing one or more items, the system comprising a control unit configured to implement the order fulfilment method.

### TECHNICAL FIELD

The present disclosure falls within the field of ASRS (for automated storage and retrieval system) storage solutions, specifically automated storage and retrieval systems, hereinafter referred to as ASRS systems, which are computer-controlled installations configured to automatically move loads, generally containers, in given storage spaces in a storage structure such as a rack and to retrieve them.

### BACKGROUND

To this end, ASRS systems comprise automated means of transport, which may encompass various technical solutions, such as motor-driven conveyors, in particular roller conveyors, ascent devices, descent devices, shuttles, storage and retrieval machines, or even automated guided carriages (or AGVs), travelling in two horizontal dimensions of the space, or even travelling in a vertical third dimension, these means of transport being configured to ensure the automated loading of the storage structure with containers which are the most part are single-item containers intended for use as a collection container.

A single-item container is understood to mean the fact that the volume of the container contains one or more structurally identical items, i.e. items of identical sizes, shapes and thus structures. In some cases, the containers may contain items that are structurally identical but not strictly identical, for example items that are structurally identical but of different colours. In the context of the present disclosure, the contents of the containers may refer to items that can be structurally identical or not structurally identical.

The containers used are part of the ASRS system and can typically take the form of a tote, often a plastic tote. These containers have various functions specifically designed to allow them to cooperate with the other ASRS elements, and in particular with the means of transport, or with the ASRS storage structure.

Thus, by way of example, these specific functions can be:
specific functional surfaces and dimensions for mounting in the storage spaces of the storage structure, for example for mounting them on brackets of a rack,
a mechanical strength designed to bear a load, without sagging and thus without running the risk of falling, or to bear such a load even in the event of water being sprayed from a fire-fighting system,
functional surfaces configured to be gripped by automated gripping systems, for automated loading/unloading thereof, in the storage spaces, for example positive (protruding) reliefs or negative (recessed) reliefs for engaging typically with male or female parts, a mechanized gripper, etc.

These storage and retrieval systems are notably applicable for fulfilling one or more orders. An order may comprise one item, or multiple identical items. However, an order is often made up of a combination of different items.

To this end, storage solutions typically comprise one or more manual or robotic order fulfilment stations. Such a (manual) order fulfilment station may thus comprise an order fulfilment workstation for an operator, typically with a digital interface, typically a screen, displaying the composition of the current order, and allowing the operator to pick one or more items, from one or more typically single-item containers delivered automatically by the means of transport from the storage structure to the station and to deposit them manually into an order packaging, conventionally an order box intended for despatch, at the station, the box being open for assembly of the order. This box is then closed, typically by folding down upper flaps, often for despatch or delivery.

The order station may itself be automated, specifically comprise to this end an order fulfilment robot, typically a multi-axial arm equipped with a gripper, often a pneumatic suction system or a fingered gripper, this robot being configured to automatically pick one or more items from the container(s), often single-item container(s), and to deposit them in the order box, at the order fulfilment station.

Regularly, and as orders are made, the specific containers, typically single-item containers, of the ASRS system are emptied and the storage system of the ASRS system needs to be re-stocked with single-item containers filled with said single items.

To this end, storage warehouses comprise, in addition to the storage structure of the ASRS system receiving the specific containers automatedly served by the automatic means of transport for the purpose of order fulfilment, a mass storage unit with a buffer function, inside which closed and typically single-item boxes for re-stocking are stored. Such a mass storage unit may itself be automated (or not automated).

When a re-stock is required, an often single-item box is retrieved from the mass storage unit and then opened, typically by unfolding upper flaps of the box, and then the items in the single-item box are retrieved in full and loaded into one of the ASRS-specific, fully or partially empty containers at a stocking workstation, with a view to obtaining a single-item container filled with the items. The re-stocked container is conveyed by the ASRS means of transport to one of the ASRS storage spaces.

In order to reduce the environmental footprint of the order fulfilment operations, it is known practice, in such ASRS system warehouses, to collect the box for re-stocking when it is in the open state and emptied of items, making it possible to fill the empty ASRS container and to convey it directly to one of the order fulfilment stations of the ASRS system for use as order packaging, and more specifically as an order/despatch box, inside which the operator (or the robotic arm) deposits the item(s) of the order.

The inventors have found that such a box recycling operation, from the stocking station to the order fulfilment station (or the order fulfilment stations), requires adding additional conveyors to those that already exist in the ASRS system, in order to convey empty boxes, directly from the stocking station, to one of the order fulfilment stations, bypassing the storage structure of the ASRS system, thereby in particular adversely affecting the floor size of the installation and increasing its cost.

Such an order fulfilment method can be improved.

### SUMMARY

The present disclosure will improve the situation.

A first aspect provides an order fulfilment method implemented in an automated storage and retrieval system comprising:
a storage structure which has storage spaces,
at least one order fulfilment station for fulfilling orders,
containers intended for receiving stocking boxes and order boxes.

The method comprises stocking the storage structure via items from stocking boxes each containing at least one item.

The method comprises:
/A/ loading each of the stocking boxes onto a container to form storage assemblies,
/B/ transporting the storage assemblies to storage spaces in the storage structure,
/C/ fulfilling orders at said at least one order fulfilment station, including, for all or some of the orders, picking at least one item from at least one of the storage assemblies and placing said at least one item into an order box,
/D/ at least one stocking box being emptied by said picking during one of the order fulfilment operations in /C/ and wherein the stocking box emptied of said at least one item is used as said order box for at least one of the orders in /C/.

The features set forth in the following paragraphs may optionally be implemented independently of one another or in combination with one another:

In one embodiment, all or some of the stocking boxes are single-item boxes each comprising one or more structurally identical items.

In one embodiment, during the loading operations in /A/, all or some of the stocking boxes loaded onto the containers are closed boxes and wherein said storage assemblies containing the boxes are stored in a closed state in said storage spaces in the storage structure.

In another embodiment, during the loading operations in /A/, all or some of the stocking boxes loaded onto the containers are open boxes, and wherein said storage assemblies containing the boxes are stored in an open state in said storage spaces in the storage structure.

In one embodiment, at least one order is a combination of items which is identical to the contents of the stocking box of said storage assembly, said method comprising:
/E/ retrieving said storage assembly from said storage space and transporting said stocking box from said storage assembly directly to the exit of the storage and retrieval system, thereby forming the order box.

In one embodiment, said loading operations in /A/ also include loading at least one container with a box empty of items to form an empty storage assembly, and transporting said empty storage assembly to one of the storage spaces in the storage structure,
and wherein at least one of the order boxes in /C/ is the box, empty of items, of said empty storage assembly that has been retrieved from said storage space.

In one embodiment, at least one of the orders in /C/ is a combination of items comprising a sub-combination, corresponding to the contents of the stocking box of said storage assembly, from which one or more items might have been removed, and wherein, during step /C/:
said storage assembly is retrieved from said storage space and transported to said at least one order fulfilment station;
at least one second storage assembly comprising one or more items supplementing the combination of items with respect to the sub-combination, is retrieved from one of said storage spaces and transported to the order fulfilment station,
at least one item is transferred from said at least one second storage assembly to said stocking box of said storage assembly containing the sub-combination until the combination is obtained, and then, successively,
transporting said stocking box of said storage assembly containing the combination, in the form of an order box, to an exit of the storage and retrieval system.

In one embodiment, a box of a storage assembly is withdrawn from the storage structure and emptied according to /D/, and wherein the method comprises:
/DA/ storing the storage assembly comprising the container and the box emptied of items in the storage structure,
and wherein the stocking box used as an order box in /D/ is the box of said storage assembly, emptied of items, that was retrieved from said storage space after storage according to /A/.

In one embodiment, the automated storage and retrieval system comprises:
the storage structure containing the storage spaces,
the containers configured to be stored in the storage spaces,
said at least one order fulfilment station, remote from the storage structure, where the order is assembled during the order fulfilment operations according to /C/,
automated means of transport configured to transport storage assemblies between said at least one order fulfilment station and the storage structure and to:
   transport, prior to one of the order fulfilment operations in /C/, at least one first storage assembly comprising the container and the stocking box containing said at least one item necessary for one of the orders from said storage space in the storage structure to said at least one order fulfilment station, and
   transport, prior to said order fulfilment in /C/, a second storage assembly comprising the container and an order box from said storage space in the storage structure to said at least one order fulfilment station, and wherein, during said order fulfilment in /C/, said method comprises:
transferring said at least one item from said stocking box of said first storage assembly to the order box of the second storage assembly.

In one embodiment, said automated means of transport may be configured to:
transport, after the order fulfilment in /C/, said first storage assembly comprising the container and the stocking box from which said at least one item has been retrieved from the order fulfilment station to one of the storage spaces in the storage structure, and/or
transport said order box to an exit of the storage and retrieval system.

In one embodiment, the method may include, between one of the order fulfilment operations according to /C/ at the order fulfilment station, on the one hand, and completing said order, on the other hand:
transporting and storing the storage assembly comprising the order box receiving said at least one item of the order in a storage space in the storage structure, prior to transporting the storage assembly containing the order box to an exit of the storage and retrieval system.

In one embodiment, the automated storage and retrieval system may comprise at least one stocking workstation for the loading operations /A/ for loading said stocking boxes onto the containers, thereby forming storage assemblies, said stocking station being remote from the storage structure, and automated means of transport configured to transport the storage assemblies from the re-stocking workstation to the storage spaces in the storage structure.

In one embodiment, the automated means of transport may comprise at least one fleet of automated guided carriages configured to transport:
the storage assemblies each comprising the container and the stocking box and/or
at least one storage assembly comprising the container and the order box comprising said at least one item of the order.

In one embodiment, the transfer of at least one item during one of the order fulfilment operations in /C/, at the order fulfilment station, is effected while the first storage assembly comprising said stocking box is mounted on a first automated guided carriage, and while the second storage assembly comprising said order box is mounted on a second automated guided carriage, the first carriage and the second carriage being arranged in two adjacent parking spaces facing an operator, or positioned inside the range of action of a robotic arm of the order fulfilment station.

In one embodiment, the method may comprise an order finalizing step including transporting said order box to an exit of said storage and retrieval system by way of one of the multiple automated guided carriages on which is mounted a storage assembly comprising a container and the order box containing said order and wherein the order box is transported by the automated guided carriage in the direction of the exit, and wherein the method provides separating the order box comprising the order from the container and then transporting the order box separated from the container to the exit of the storage and retrieval system.

In one embodiment, said stocking boxes comprise closure flaps configured to close an upper opening of the box, and wherein said storage assemblies each comprising the container and said stocking box are configured to allow the closure flaps to be opened, and wherein the method ensures the opening of the containers of said storage assemblies by way of opening the closure flaps and retention of the folded-down closure flaps against side walls of the box by the addition of a retaining system.

In one embodiment, the containers comprise a bottom and side rims configured for lateral retention of the stocking box or for retention of the order box.

The present disclosure also relates to an assembly comprising an automated storage and retrieval system capable of being suitable for implementing the method according to the present disclosure and boxes containing one or more items, said storage and retrieval system comprising:
containers,
a storage structure comprising the storage spaces for the containers,
at least one order fulfilment station remote from the storage structure,
automated means of transport configured to transport containers between said at least one order fulfilment station and the storage structure, and automated means of transport configured for storage transport between said at least one order fulfilment station and an exit of the storage and retrieval system comprising a fleet of automated guided carriages,
the automated guided carriages each being equipped with a communication module configured to wirelessly receive and transmit data from and to a remote control unit, which is a computer, and wherein said remote control unit ensures management and control of the means of transport, including management of the guide trajectories of the automated guided carriages on a running surface.

According to the present disclosure:
a) the boxes are accommodated on the containers, thereby forming storage assemblies,
b) the storage assemblies are stored in the storage spaces in the storage structure, and wherein said control unit has one or more processors, a memory and a set of instructions configured to implement the order fulfilment method according to the present disclosure.

### BRIEF DESCRIPTION OF THE DRAWINGS

Other features, details and advantages will become apparent on reading the detailed description below and on analyzing the appended drawings, in which:

FIG. 1 is a schematic view of a warehouse according to the present disclosure which comprises, as input, typically single-item stocking boxes, and, as output, order boxes comprising the item(s) of the order.

FIG. 2 is a schematic view of the operation of a warehouse according to the prior art which comprises a mass storage unit for stocking boxes, and an automated storage and retrieval system comprising a storage structure served by automated means of transport, the stocking boxes being completely emptied of the items that are transferred into containers of the storage and retrieval system, prior to the transfer of the containers stocked with the items into the storage structure, the view illustrating a recycling of the stocking box, emptied of items, that is conveyed to serve as an order box on fulfilment of an order.

FIG. 3 is a view of one embodiment of a storage assembly according to the present disclosure which comprises a container and a box, originally a stocking box, accommodated in the container, FIG. 3 illustrating upper flaps of the box held open by side walls of the container, and according to one possible solution among others for keeping the box open.

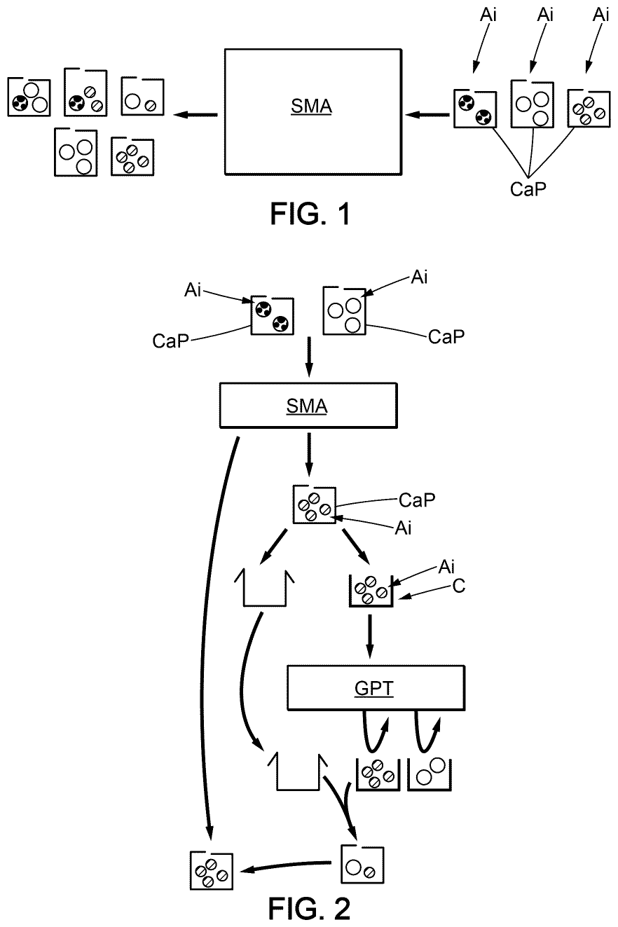

FIG. 4 is a schematic view of the method according to the present disclosure, which comprises:
at the entrance of the storage and retrieval system: stocking involving loading stocking boxes into storage containers and storing storage assemblies in storage spaces in the storage and retrieval system, possibly keeping the boxes closed, and, where appropriate;
withdrawing the storage assemblies from the storage structure and then opening the boxes,
taking an inventory of the items contained in the open boxes of the storage assemblies,
preparing an order involving withdrawal from a storage assembly and then collecting at least one item of an order, with a view to transferring that item into an order box,
closing the order box once the combination of the item(s) of the order has been assembled, and
withdrawing the storage assemblies containing the order boxes in order to transport the order boxes containing the orders to an exit of the storage and retrieval system.

FIG. 4bis is a schematic view of a possible order fulfilment operation in which items are picked from two single-item storage assemblies and transferred into the order box of a storage assembly to fulfil an order comprising a combination of separate items.

FIG. 5 illustrates a schematic view of a possible order fulfilment operation of the method in which the stocking box of a storage assembly comprises multiple items which form a sub-combination of items of the order, said box of said storage assembly being used directly as an order box without needing to empty out the items of the sub-combination.

FIG. 6 illustrates a schematic view of the opening of stocking boxes and the closing of order boxes, which can be implemented respectively:
at the start of an inventory being taken of the stocking box of said storage assembly, which involves opening the box,
and at the end of the order fulfilment operation, which involves closing the box, and said opening of the box and the closing are performed at an order fulfilment station. FIG. 7 schematically illustrates a view of the method which comprises damaged stocking boxes, which are not recycled as order boxes, and the loading of additional boxes, empty of items, into containers and storing them in storage spaces in the structure.

FIG. 8 is one possible example of an automated storage and retrieval system comprising, in a secure enclosure, storage racks separated by aisles, and a fleet of robotic carriages configured to feed storage assemblies to the storage spaces on the racks according to the method of the present disclosure.

FIG. 9 is another variant of the storage and retrieval system allowing the implementation of the method.

FIG. 10 is a detail view of FIG. 9.

### DETAILED DESCRIPTION

The present disclosure relates to an order fulfilment method implemented in an automated storage and retrieval system 1 comprising:
a storage structure GPT which has storage spaces,
at least one order fulfilment station for fulfilling orders,
containers C intended for receiving stocking boxes CaP and order boxes CaC.

The storage structure may have various designs, and in particular:

According to a first design, the storage structure GPT may comprise one or more racks, which have storage spaces one on top of another, the storage spaces being arranged at different heights and having lateral loading openings, allowing them to be loaded independently of one another, and as illustrated for example in the embodiments in FIGS. 8 and 9. Such racks typically comprise multiple columns of storage spaces one on top of another, the various columns being distributed along the length of the storage rack.

The racks can typically be disposed parallel to one another and separated by aisles. In such an embodiment, the containers are placed into/retrieved from the storage spaces in a substantially horizontal direction, the container typically resting on two mechanical interfaces secured to uprights of the storage rack, for example as taught in the document WO2024056464. The depth of the storage spaces makes it possible to support a single container, or multiple containers, one behind another.

According to a second design, the storage structure GPT makes it possible to define multiple juxtaposed storage columns each configured to receive a stack of containers, and the columns can be loaded and unloaded by automated guided carriages travelling on a track, or rails arranged above the storage columns. The automated guided carriages comprise means for gripping and lifting containers, and as taught by the document FR 3113658 A1, make it possible to grasp, in one of the storage columns, the upper container of the stack and to lift it above the runway or the rails, the automated guided carriage comprising motor-driven means of horizontal movement allowing it to travel on a horizontal surface and to transport the container to an order fulfilment station, typically on the periphery of the storage structure.

Other storage structure designs are possible without departing from the scope of the present disclosure, for example the design taught by the document US2018/0148259.

The storage and retrieval system has at least one order fulfilment station for fulfilling orders. Said at least one order fulfilment station typically comprises one or more order fulfilment stations.

Said at least one order fulfilment station is arranged outside of the storage spaces, for example to the side at a distance from said storage structure, typically on a floor of a warehouse.

At least one order fulfilment station may be manual. Such a manual order fulfilment station 5a may thus comprise an order fulfilment workstation for an operator, typically with a digital interface, typically a screen, displaying the composition of the current order, and allowing the operator to pick one or more items in order to deposit them manually into an order box, intended for despatch, at the order station, the box being open for assembly of the order.

The order station 5b may itself be automated, specifically comprise to this end an order fulfilment robot, typically a multi-axial arm equipped with a gripper, often a pneumatic suction system or a fingered gripper. Such an order fulfilment robot is configured to automatically pick one or more items and to deposit them into an order packaging, at the order fulfilment station.

Generally speaking, the storage and retrieval system comprises automated means of transport configured to transport the containers between said at least one order fulfilment station and the storage structure and typically automated means of transport configured for storage transport between said at least one order fulfilment station and an exit So of the storage and retrieval system.

Generally speaking, in particular when the storage structure comprises storage racks 2, the means of transport may comprise:
according to a first variant, a storage and retrieval machine arranged in particular in an aisle between two storage racks and configured to laterally load/unload the storage spaces arranged along the height and length of the storage racks, or even typically automated conveyors configured to collect the containers unloaded by the storage and retrieval machine and convey them to the order fulfilment station, or a fleet of robots travelling on the ground, or on a running table, which are configured to collect the containers from the storage and retrieval machine and convey them to said at least one order fulfilment station,
according to a second variant, shuttles travelling along the various heights of the storage spaces on horizontal rails, the shuttles being configured to unload/load containers from/into storage spaces and convey them to a descending device/ascending device configured to vertically move the containers conveyed by the shuttles and bring them down, or lift them up when the containers are conveyed in a reverse direction, or even typically automated conveyors configured to collect the containers unloaded by the descending device and convey them to the order fulfilment station, or a fleet of robots travelling on the ground, or on a running table, which are configured to collect the containers from the storage and retrieval machine and convey them to said at least one order fulfilment station,
according to a third variant, first automated guided carriages can be configured to travel on the ground to an aisle between two storage racks and second automated guided carriages can be configured to move along the height and length of the racks to access storage spaces, grasp a container, and then deposit it on one of the first carriages, as taught by US20170267452A1.
according to a fourth variant, automated guided carriages 3 each comprising means of horizontal movement, such as motor-driven casters configured to move the automated guided carriage on a running surface such as the ground or a table, for example in the X and Y directions in FIG. 8, and climbing means comprising motor-driven toothed wheels configured to couple with climbing elements extending vertically along the height of the storage racks, typically secured to the uprights of the storage racks, and configured to allow the vertical movement of the automated guided carriage to a height of a storage space.

According to this fourth variant, a gripping device comprises a mounting fitted movably relative to a chassis of said carriage between:
a deployed position, in which said mounting extends at least partially on a side edge of said carriage out of alignment with said chassis; and
a retracted position, in which said mounting is accommodated facing said chassis.

In the deployed position, the movable mounting allows the container to be lifted from said storage space when the automated guided carriage is moved by the climbing means, before the movable mounting is retracted to the retracted position in order to unload a storage space. Conversely, a container is loaded into a storage space by deploying the movable mounting from the retracted position to the deployed position and then moving the automated guided carriage downwards until the container rests in said storage space, as taught for example by the document EP3638607A1.

According to the second design of the storage structure GPT having multiple storage columns, the means of transport comprise at least the automated guided carriages travelling on tracks arranged above the storage columns, the self-guided carriages comprising means for gripping and lifting containers, as taught by the document FR 3113658 A1, or even ascending devices/descending devices for lifting/lowering the containers when said at least one order fulfilment station is arranged in the bottom part of the storage structure.

Generally speaking, a control unit, typically remote control unit, which comprises at least one microprocessor and a memory containing sets of instructions, is configured to control the means of transport and to allow containers to be conveyed into the storage and retrieval system, from the storage spaces to said at least one order fulfilment station, or vice versa from said at least one order fulfilment station to the storage spaces.

Said control unit may also be configured to control the means of transport to convey the containers from an entrance ER of the storage and retrieval system, in order to load the spaces in the storage structure, or to convey order boxes CaC prepared at said order fulfilment station to an exit So of the storage and retrieval system.

Generally speaking, and when the means of transport comprise automated guided carriages 3 travelling horizontally in a travelling area, on the ground or on a running table, the storage structure GPT, in particular the storage racks 2, the travelling area may have a security barrier BR around the periphery, preventing an operator from accessing the travelling area, or a virtual security barrier for at least partially deactivating the storage and retrieval system when an operator passes through a detection beam of the virtual barrier.

Generally speaking, and as illustrated in FIG. 8:
the entrance ER of the storage and retrieval system comprises a passage through the barrier BR, and/or
the exit So of the storage and retrieval system comprises a passage through the barrier BR.

Generally speaking, the automated guided carriages are each equipped with a communication module configured to wirelessly receive and transmit data from and to said remote control unit, which is a computer, and more particularly the communication module is configured to receive guidance instructions transmitted by the control unit.

Said remote control unit ensures management and control of the means of transport, including management of the guide trajectories of the automated guided carriages on a running surface, which may be the ground or a running table.

Said control unit typically comprises a database recorded in a memory, associating specific containers with contents. This database may be updated in real time, for example when the container is being stocked, when items are being collected at said at least one order fulfilment station, or even more generally during an inventory-taking step performed by an operator.

Such an update can be done by means of a user interface when the collection is manual, or when an inventory is being taken, or by means of a bar code reader, or automatically when the order fulfilment station is robotic by a bar code viewing or reading system.

According to the present disclosure, the method comprises stocking the storage structure via items Ai from stocking boxes CaP each containing at least one item Ai.

The stocking boxes CaP are typically stored in a mass storage unit typically arranged in the same warehouse as the automated storage and retrieval system. The mass storage unit may itself be automated (or not automated). The stocking boxes CaP are preferably stored in a closed state in the mass storage unit, and contain the items necessary to stock the containers of the storage and retrieval system.

All or some of the stocking boxes CaP may be single-item boxes each comprising one or more structurally identical items Ai.

The order boxes CaC are the packaging used to consolidate and despatch the items of an order. In the context of automated storage and retrieval systems ASRS, these boxes are often prepared at an order fulfilment station, where the items are picked from containers and placed into the order boxes, which are then typically closed and often ready for despatch.

The containers C intended to receive stocking boxes CaP and order boxes CaC are an integral part of the storage and retrieval system.

The containers C are part of the ASRS system and can typically take the form of a tub, often a plastic tote. These containers may have various functions specifically designed to allow them to cooperate with the other ASRS elements, and in particular with the means of transport, or with the ASRS storage structure.

Thus, by way of example, these specific functions can be:
specific functional surfaces and dimensions for mounting in the storage spaces of the storage structure, for example for mounting them on fixing interfaces, such as brackets of a rack,
a mechanical strength designed to bear a load, without sagging and thus without running the risk of falling, or even to bear it even in the event of water being sprayed from a fire-fighting system,
functional surfaces configured to be gripped by automated gripping systems of the automated means of transport, for automated loading/unloading thereof, in the storage spaces, for example positive (protruding) reliefs or negative (recessed) reliefs for engaging typically with male or female parts, a mechanized gripper.

The containers C typically comprise a bottom and side rims (or side walls) configured for lateral retention of the stocking box CaP or for lateral retention of the order box CaC.

The order fulfilment method according to the present disclosure comprises:
/A/ loading each of the stocking boxes CaP onto a container C to form storage assemblies ES,
/B/ transporting the storage assemblies ES to storage spaces in the storage structure GPT,
/C/ fulfilling orders at said at least one order fulfilment station, including, for all or some of the orders, picking PICK at least one item Ai from at least one of the storage assemblies ES and placing said at least one picked item Ai into an order box CaC.

Thus, /A/ envisages loading the stocking boxes CaP onto the container C, thereby advantageously making it possible to stock the ASRS without requiring the stocking box to be emptied, and by contrast to the practice known to those skilled in the art that was described in the introduction, for which the item(s) of the stocking box are transferred into a container after opening the box.

The loading of the stocking box into the container according to /A/, typically performed at a stocking workstation PaP, is advantageously carried out while the stocking box still has its contents, eliminating the need to empty the stocking boxes prior to storage, thus simplifying the stocking procedure in comparison to previous methods, and limiting human error.

Generally speaking, said at least one stocking workstation is typically remote from the storage structure GPT, typically at the periphery of the storage and retrieval system 1, and located outside the barrier BAR.

The stocking box can be kept closed during the loading operation. The storage assemblies each comprising the container and the box are then transferred in a closed state into the storage space of the structure.

In such a case, an inventory of the stocking box can be taken when the box is open, typically at the order fulfilment station.

Generally speaking, when an inventory is being taken, at the stocking workstation or at said at least one order fulfilment station, the operator can find out, by using the user interface or by reading a bar code, the contents (the items) of the box in order to update the database. The interface in particular makes it possible to find out:
the nature of the item,
the number of items,
etc.

Generally speaking, the loading of the closed stocking boxes onto the containers according to /A/, and then the transport of the storage assemblies ES to the storage spaces according to /B/, has several operational advantages.

Firstly, this method reduces the number of additional handling operations required during the stocking, resulting in a decrease in the processing time required to stock the storage structure GPT.

Specifically, this procedure makes it possible to postpone the opening of the stocking boxes and open them directly at least at one order fulfilment workstation. This makes it possible to save time by limiting intermediate interventions and shifting this task to a more convenient time in the logistics flow.

In addition, when the order fulfilment station 5a is equipped with multiple workstations dedicated to order fulfilment, it becomes possible to divide the tasks of opening the boxes among multiple operators. This division also makes it possible to better manage inventory-taking operations and the associated updates in the database.

Thus, each order fulfilment station can contribute to these updates, improving the overall efficiency of the procedure and reducing the risk of errors.

According to another possibility, the stocking box of said storage assembly can be opened at the stocking workstation and then transferred in the open state to the storage space in the storage structure.

In such a case, an inventory of the stocking box can be taken when the box is open, at the stocking workstation PaP. While this inventory is being taken, the operator can use a user interface to find out the contents of the box in order to update the database.

The automated means of transport are configured for the transport of the storage assemblies from the stocking workstation to the storage spaces in the storage structure GPT.

Generally speaking, said stocking boxes CaP comprise closure flaps Vf which are configured to close an upper opening of the box and are initially closed. When opening the stocking box, special attention can be paid to open the box without degrading the closure flaps, and in such a way that the stocking box can be re-used.

Said storage assemblies each comprising the container and said stocking box can be configured to allow the closure flaps to be opened.

Generally speaking, once the flaps of the boxes have been opened, the method can envisage that the folded-down closure flaps are retained against side walls of the box by the addition of a retaining system.

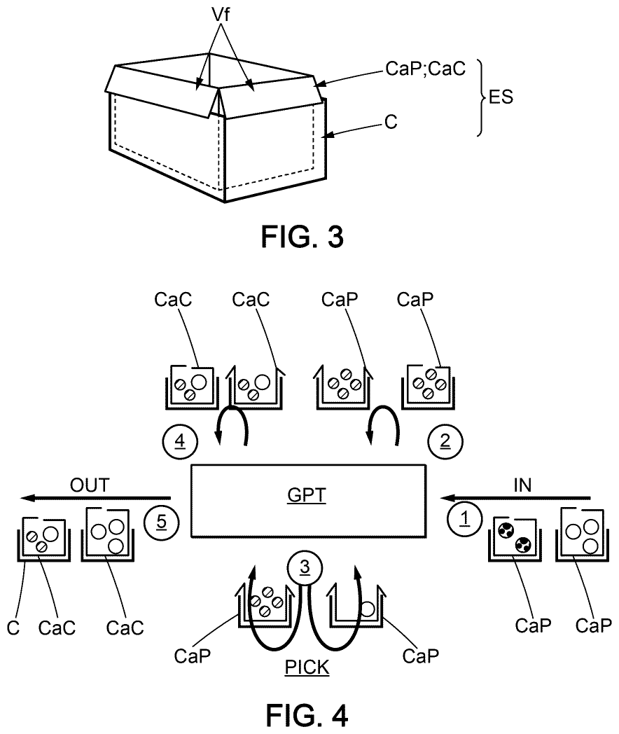

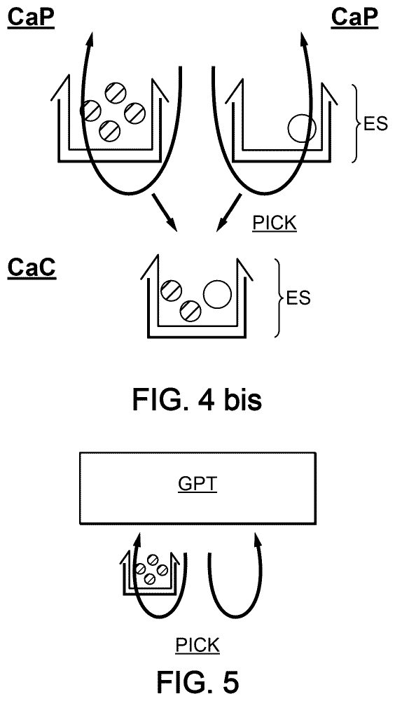

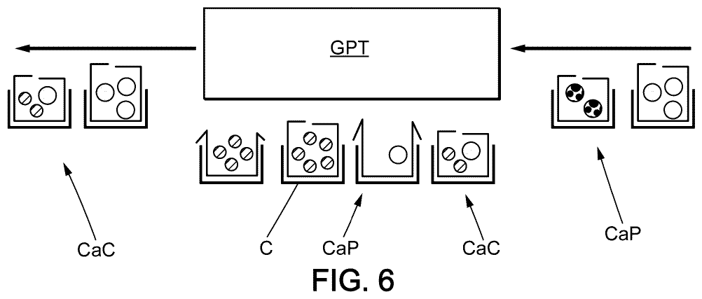

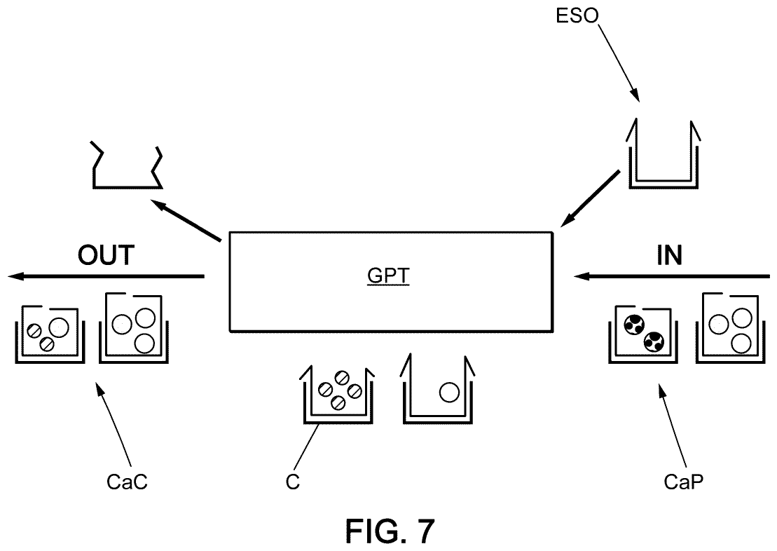

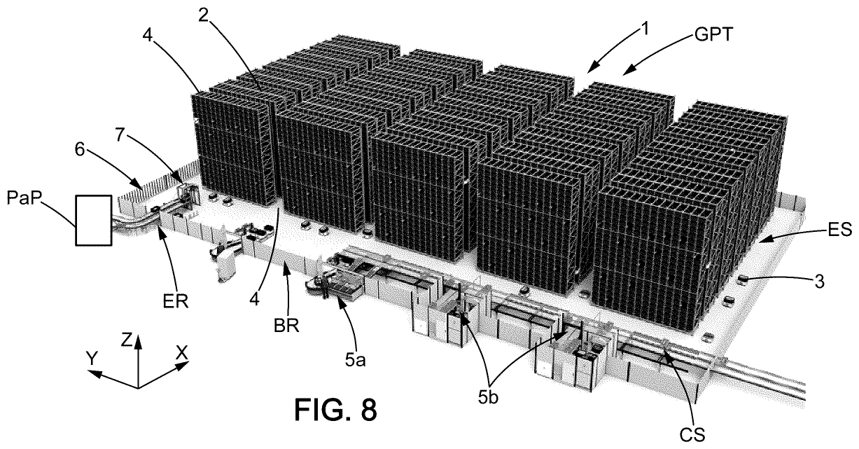

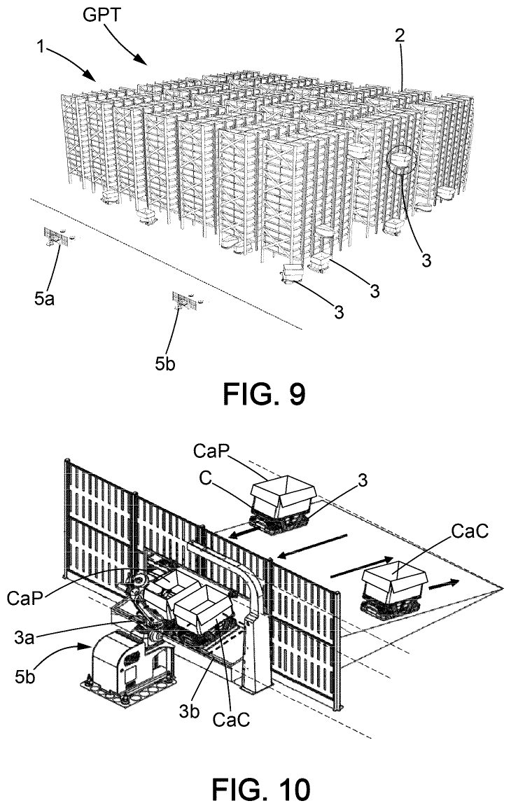

Such a retaining system may be for example specific to the container. For example, according to an embodiment illustrated non-limitingly in FIG. 3, lateral walls or rims of the containers can make it possible to immobilize the flaps Vf, each flap being retained interposed between one of the rims (or lateral walls) of the container and one of the walls of the stocking box.

Such a retaining system may be separate from the container, and for example comprise a connection, for example an elastic connection, which surrounds the flaps in order to immobilize them in the folded-down state against the side walls of the box.

Such retention of the flaps limits the risks of the flaps interfering, in particular when the means of transport are transporting the storage assemblies. Such retention is advantageous during the order fulfilment operations in /C/ in order to facilitate manual collection operations, or to ensure that a camera associated with the robotic arm of a robotic order fulfilment station can look freely into the box. Such a camera may be configured to identify the items Ai of the contents for the purpose of grasping them.

Transporting the storage assemblies ES according to /B/ to storage spaces in the storage structure GPT is performed under the control of the control unit by the automated means of transport.

Fulfilling orders according to /C/ at said at least one order fulfilment station includes, for all or some of the orders, picking at least one item Ai from at least one of the open stocking boxes CaP of the storage assemblies ES and placing said at least one picked item Ai into an order box CaC.

During the order fulfilment, picking items directly from the stocking boxes of the storage assemblies and placing them into order boxes streamlines the workflow, allowing a smooth transition of the items from stocking to despatch. This reduces the order processing time and improves the responsiveness of the system to customer requests.

Depending on the number and nature of the items of the order, /C/ may require one or more storage assemblies, and if necessary multiple instances of at least one item Ai being picked from the stocking boxes of the various storage assemblies.

With a view to order fulfilment according to /C/, the one or more storage assemblies necessary for the fulfilment of an order, from which the item(s) Ai are collected, are transported prior to the picking operation from their storage space in the storage structure GPT to said at least one order fulfilment station 5a, 5b.

The method can therefore envisage, between /B/ and /C/:
/BC/ transporting the one or more storage assemblies from the storage space(s) to the order fulfilment station 5a, 5b, this transporting being performed by the automated means of transport, under the control of the instructions from the control unit.

Notably, and according to the method according to the present disclosure: /D/ at least one stocking box CaP is emptied by said picking during one of the order fulfilment operations in /C/ and wherein the stocking box CaP emptied of said at least one item is used as said order box CaC for at least one of the orders in /C/.

Using emptied stocking boxes as order boxes for subsequent despatches represents an efficient recycling solution, reducing the waste and costs linked to the purchase of new boxes, while at the same time contributing to a smaller environmental footprint.

More particularly, such recycling can be carried out by using the means of transport of the storage and retrieval system 1, which are already necessary for the order fulfilment operations, already allowing stored items to be transported between said storage structure GPT and said at least one order fulfilment station 5a, 5b, and therefore advantageously without requiring means of transport specific to such recycling, and by contrast to the prior art described in the introduction which envisages the addition of a specific conveyor.

In some cases, recycling stocking boxes CaP into order boxes may not be sufficient to meet the needs in terms of boxes for all of the orders in /C/. This shortfall can be caused by several factors. For example, it is possible that some boxes degrade during handling operations, making them unsuitable for re-use.

Moreover, the nature of the recycled boxes, in particular as regards their dimensions and capacities, may not be suitable for all of the orders. It may therefore be the case that, depending on the specific sizes of the orders to be processed, some recycled boxes cannot be used, thus requiring additional stocking with new boxes.

According to one embodiment, said loading operations in /A/ also include the loading of at least one container C with a typically new box, empty of items and not recycled from a stocking box, to form an empty storage assembly ES0, and transporting said empty storage assembly to one of the storage spaces in the storage structure GPT. According to such an embodiment, at least one of the order boxes CaC in /C/ is the box empty of items (and not recycled from a stocking box) of said empty storage assembly which has been retrieved from said storage space GPT.

By loading containers with boxes empty of items to form empty storage assemblies, the method makes it possible to prepare ready-to-use order boxes in advance, thus optimizing the workflow, and with a view for example to comply with the different volumes needed for the orders.

Transporting these empty storage assemblies to the storage spaces ensures that the order boxes are immediately available, reducing the waiting time during the order fulfilment. Such loading can also make it possible to have available different order boxes of different dimensions/capacities, stored in the storage structure on the containers.

During the order fulfilment operations, the control unit can select, from the different sizes/capacities of empty boxes intended to form the order boxes, one of the boxes of which the capacity is suitable for the volume of the items in the order. The control unit can for example estimate by calculation a total volume of the items of the order and select, from the available empty boxes, the empty box of which the capacity is greater than the estimated total volume of the order, similar to the estimated total volume.

Generally speaking, the order boxes containing the items of the orders in /C/ are transported to the exit So of the storage and retrieval system by the means of transport of the system, and under the instructions from the control unit.

Generally speaking, and according to a first possibility, the stocking box(es) emptied in /D/ at said order fulfilment station are used as order box(es) CaC at said at least one order fulfilment station, and in particular without requiring the emptied boxes to be temporarily stored in the storage structure GPT.

According to a second possibility, a stocking box of a storage assembly ES can be withdrawn from the storage structure GPT and emptied according to /D/, and wherein the method comprises:
/DA/ storing the storage assembly ES comprising the container and the box emptied of items in the storage structure GPT, and wherein the stocking box used as an order box in /D/ is the box of said storage assembly, emptied of items, that was retrieved from said storage space after storage according to /DA/.

By withdrawing a box from a storage assembly and emptying it according to the method, the system allows the stocking box to be re-used as an order box, thus optimizing the use of resources. Temporarily storing the storage assembly comprising the container and the emptied box in the storage structure ensures efficient management of the space and materials, reducing the need for new boxes while at the same time making logistics as effective as possible and staying flexible enough to respond to changes to the order.

Thus, and generally speaking, the automated means of transport can be configured to transport the storage assemblies between said at least one order fulfilment station and the storage structure and to:
transport, prior to one of the order fulfilment operations in /C/, at least one first storage assembly ES comprising the container C and the stocking box CaP containing said at least one item necessary for one of the orders from said storage space in the storage structure to said at least one order fulfilment station, and
transport, prior to said order fulfilment in /C/, a second storage assembly comprising the container and an order box, empty of items (and recycled or not recycled from a stocking box), from said storage space in the storage structure to said at least one order fulfilment station, and wherein, during the order fulfilment in /C/, said method comprises, at the order fulfilment station:
transferring said at least one item from said stocking box of said first storage assembly to the order box of the second storage assembly or conveyed by the second assembly.

Generally speaking, the method may include, between one of the order fulfilment operations according to /C/ at the order fulfilment station 5a, 5b, on the one hand, and completing said order, on the other hand:
transporting and storing the storage assembly ES comprising the order box CaC receiving said at least one item of the order in a storage space in the storage structure GPT, prior to transporting the storage assembly containing the order box to an exit So of said storage and retrieval system.

By transporting and storing the storage assembly containing the order box into and in the storage structure, the method makes it possible to efficiently manage the orders awaiting despatch. This intermediate step ensures that the orders are organized and ready for despatch as soon as required, thus optimizing the workflow and reducing the processing times. Temporarily storing the order boxes improves resource management and use of the space, while at the same time ensuring fast and efficient fulfilment of the despatches.

Generally speaking, said automated means of transport may thus be configured to:
transport, after the order fulfilment in /C/, said first storage assembly ES comprising the container C and the stocking box CaP from which said at least one item has been retrieved from the order fulfilment station 5a, 5b to one of the storage spaces in the storage structure GPT, and/or
transport said order box CaC containing the items of the order to the exit So of said storage and retrieval system 1.

In one embodiment, the automated means of transport comprise at least said fleet of automated guided carriages 3 which are configured to transport:
the storage assemblies each comprising the container and the stocking box and/or
at least one storage assembly comprising the container and the order box comprising said at least one item of the order.

In one embodiment, the transfer of at least one item Ai during one of the order fulfilment operations in /C/, at the order fulfilment station 5a, 5b, is effected while the first storage assembly comprising said stocking box CaP is mounted on a first automated guided carriage 3, and while the second storage assembly comprising said order box is mounted on a second automated guided carriage 3, the first carriage and the second carriage being arranged in two adjacent parking spaces facing an operator, or positioned inside the range of action of a robotic arm of the order fulfilment station, as illustrated by way of example in FIG. 10.

In one embodiment, the method comprises completing the order, including transporting said order box CaC to an exit So of said storage and retrieval system 1 by way of one of the automated guided carriages bearing a storage assembly comprising a container C and the order box CaC containing said order. Said order box CaC can be transported by the automated guided carriage 3 in the direction of the exit, and then the method envisages separating the order box CaC comprising the order of said container, then transporting the order box separated from the container to the exit of the storage and retrieval system, for example via a, typically roller, conveyor.

Further possible advantages of the method according to the present disclosure are set out below.

In one embodiment, at least one of the orders is a combination of items which is identical to the contents of the stocking box CaP of said storage assembly ES, and said method may comprise
/E/ retrieving said storage assembly ES from said storage space and transporting said stocking box CaP from said storage assembly directly to the exit So of the storage and retrieval system, thereby forming the order box CaC.

Such retrieval of said storage assembly ES and transport of the stocking box CaP according to /E/ is performed by the automated means of transport, and possibly without passing through said at least one order fulfilment station, in particular when the means of transport comprise a fleet of automated guided carriages 3.

In particular, and when the stocking box CaP has been stored in the closed state in the storage structure GPT, it is not necessary to open the box for it to make up the order box. No picking is necessary and its contents can be despatched as is.

By retrieving a storage assembly of which the contents are identical to an order, the method allows the stocking box to be transported directly to the exit of the system, thereby simplifying the order fulfilment procedure.

This method means it is not necessary to transfer the items to a new order box, thereby reducing the processing time and the costs associated with additional packaging.

In another embodiment, at least one of the orders in /C/ is a combination of items comprising a sub-combination of items, corresponding to the contents of the stocking box CaP of said storage assembly ES, from which one or more items might have been removed,
and wherein, during step /C/:
said storage assembly ES is retrieved from said storage space and transported to said at least one order fulfilment station 5a, 5b;
at least one second storage assembly ES comprising one or more items supplementing the combination of items with respect to the sub-combination, is retrieved from one of said storage spaces and transported to the order fulfilment station,
at least one item is transferred from said at least one second storage assembly to said stocking box of said storage assembly containing the sub-combination until the combination of items is obtained, and then, successively,
preferably after the box has been closed, transporting said stocking box of said storage assembly containing the combination of items, in the form of an order box, to an exit of the storage and retrieval system.

The transporting operations are carried out by automated means of transport under the instructions from the control unit.

By making it possible to fulfil orders comprising a sub-combination of items corresponding to the contents of a stocking box, the method optimizes the use of the available resources.

Transferring items from a second storage assembly to supplement the combination of items in the stocking box reduces the need for additional handling, thereby improving the efficiency of the order fulfilment procedure.

This method allows a greater flexibility in terms of inventory management, since it makes it easier to assemble complex orders while at the same time minimizing the associated movements and costs.

According to another aspect, the present disclosure relates to an assembly comprising an automated storage and retrieval system capable of being suitable for implementing the method according to the present disclosure and boxes containing one or more items, said storage and retrieval system comprising:
containers C,
a storage structure GPT comprising the storage spaces for the containers,
at least one order fulfilment station 5a, 5b remote from the storage structure,
automated means of transport configured to transport the containers between said at least one order fulfilment station and the storage structure and automated means of transport configured for storage transport between said at least one order fulfilment station and an exit of the storage and retrieval system.

Said storage and retrieval system may in particular be that described in the context of the order fulfilment method. The storage structure GPT may be of various designs, and the automated means of transport may be of various kinds, as described above. The means of transport are controlled by the instructions from the control unit.

In one embodiment, the means of transport comprise in particular a fleet of automated guided carriages 3.

The automated guided carriages are each equipped with a communication module configured to wirelessly receive and transmit data from and to said remote control unit, which is a computer, and wherein said remote control unit ensures management and control of the means of transport, including management of the guide trajectories of the automated guided carriages on a running surface.

Said control unit may in particular have the functions that have been described in the context of the method.

According to said assembly according to the present disclosure:
a) the boxes containing the item(s) are accommodated on the containers C, thereby forming storage assemblies ES,
b) the storage assemblies are stored in the storage spaces of the storage structure GPT

According to said assembly according to the present disclosure, said control unit has one or more processors, a memory and a set of instructions configured to implement the order fulfilment method according to the present disclosure.

In particular, the instructions are configured to control the transport means, in order to recycle a box emptied at said at least one order fulfilment station as an order box at said order fulfilment station, for a subsequent order.

The storage assemblies preferably comprise containers that accommodate single-item boxes containing multiple structurally identical items which can be picked from during step /C/ of the method.

The storage structure also accommodates storage assemblies comprising containers that accommodate boxes intended for use as open order boxes empty of items. They may be boxes empty of items that previously contained one or more items emptied out at said order fulfilment station, or typically new boxes loaded in the empty state at the stocking workstation.

An embodiment illustrated in FIG. 8 Will Be Described.

The storage and retrieval system comprises a storage structure which comprises a plurality of storage racks 2, disposed parallel to one another and separated by aisles. The storage racks comprise spaced-apart uprights resting on a floor of the warehouse.

Each storage rack 2 comprises multiple columns of storage spaces one on top of another and distributed along the length of the rack, the storage spaces being realized by pairs of mechanical interfaces, such as brackets, secured to the uprights, the two mechanical interfaces facing one another to support a container. The storage spaces have lateral openings, allowing them to be loaded and unloaded.

The storage racks are served by a fleet of automated guided carriages 3 which comprise means, each a means of horizontal movement, such as motor-driven casters configured to move the automated guided carriage on a running surface such as the ground or a table, for example in the X and Y directions, and climbing means typically comprising motor-driven toothed wheels configured to couple with climbing elements extending vertically along the height of the storage racks, typically secured to the uprights of the storage racks, and configured to allow the vertical movement of the automated guided carriage to a height of a storage space. The climbing elements may typically be toothed racks or roller chains, extending vertically and secured to the uprights of the storage racks. The automated guided carriages each comprise a gripping device configured to load a container into one of the storage spaces or, conversely, to unload it.

The gripping device comprises a mounting fitted movably relative to a chassis of said carriage between:
a deployed position, in which said mounting extends at least partially on a side edge of said carriage out of alignment with said chassis; and
a retracted position, in which said mounting is accommodated facing said chassis.

In the deployed position, the movable mounting allows the container to be lifted from said storage space when the automated guided carriage 3 is moved by the climbing means, before the movable mounting is retracted to the retracted position in order to unload a storage space. Conversely, a container is loaded into a storage space by deploying the movable mounting from the retracted position to the deployed position and then moving the automated guided carriage downwards until the container rests in said storage space.

Thus, the automated guided carriages 3 are configured to travel on the ground, in an area delimited by a physical barrier BR, and only in one of the aisles between two storage racks, then to couple to the storage rack, in line with one of the columns of the storage space, and then to go up to the level of the storage space that is to be served. The physical barrier BR prevents an operator from accessing the area of travel of the carriages during nominal operation. Such a physical barrier has an access door allowing access to the secure area for maintenance purposes.

A stocking workstation PaP is located outside of the secure area and allows the implementation of step /A/ of the method, specifically loading of a stocking box CaP containing one or more, typically structurally identical, items onto a container C, thereby forming a storage assembly, and said stocking box might stay closed.

An input conveyor 6 is configured to automatically convey said storage assembly to a transfer device 7, which is configured to load said storage assembly onto one of the automated guided carriages parked at the base of the transfer device 7.

Said control unit communicates wirelessly with a communication module of the automated guided carriage on which said storage assembly is mounted such that it moves on the ground to an aisle between two racks, and then, after the toothed wheels have been coupled to the climbing elements, makes the automated guided carriage 3 move vertically up to the height of an empty storage space which is loaded by deploying the movable mounting.

Order fulfilment stations 5a are arranged in particular around the periphery of the peripheral barrier and are manual order stations 5a for which operators fulfil orders outside of the physical barrier BR. The system further comprises automated/robotic order fulfilment stations 5b.

As orders are made, the stocking boxes CaP of the storage assemblies are emptied and can optionally be temporarily stored in the storage racks by the automated guided carriages.

When an order is being put together, the control unit can select, from among the available empty boxes stored in the storage racks, one of the empty boxes of which the capacity is suitable for containing the items of an order.

The control unit sends instructions to one of the automated guided carriages 3 to convey said storage assembly comprising the selected empty box from said storage space on the rack to the order fulfilment station, for example the manual order station.

The operator collects the empty box intended for recycling as an order box by separating it from the container. The control unit then conveys the one or more storage assemblies containing the items from the storage structure to the order fulfilment station to allow the operator to pick the item(s) directly from the open stocking boxes of the various assemblies and transfer them into the order box CaC.

Once the picking operation(s) has/have been completed, the operator closes the box by folding down the closure flaps Vf and then transfers the closed order box CaC which is conveyed by an output conveyor to an exit So of the storage and retrieval system 1.

The embodiment in FIGS. 9 and 10 also comprises storage racks 2 and automated guided carriages, which are configured to travel on the ground and access storage spaces to load the storage assemblies therein and unload the latter therefrom, as in FIG. 8.

This embodiment is distinguished in that the transfer of at least one item during one of the order fulfilment operations in /C/, at the order fulfilment station, is performed while the first storage assembly comprising said stocking box CaP is mounted on a first automated guided carriage 3a, and while the second storage assembly comprising the, typically recycled, order box CaC is mounted on a second automated guided carriage 3b.

The first carriage 3a and the second carriage 3b are arranged in two adjacent parking spaces facing an operator, allowing the operator to pick an item from the stocking box CaP and deposit it into the order box (not illustrated). The two parking spaces may also be arranged in the field of action of a robotic arm of the robotic order fulfilment station 5b and as illustrated in FIG. 10, so that the robotic arm does the picking.

Once the order has been completed, the order box can be closed, and said assembly comprising the container and closed order box can be conveyed by the second carriage 5b to an exit of the storage and retrieval system.

Generally speaking, and as illustrated schematically in FIG. 4, the method makes it possible in particular successively to:
load the storage assemblies in /A/, the closed stocking boxes CaP, according to a step 1 in the storage structure GPT,
open the stocking boxes CaC of the storage assemblies according to a step 2,
take an inventory and update the database and/or pick items during the fulfilment of an order according to a step 3,
close the, typically recycled, order boxes containing the picked items, according to step 4,
take away the closed order boxes of the order, which may have been temporarily stored in the storage structure.

FIG. 4bis is a detailed diagram of the picking of items from two storage assemblies ES comprising single-item stocking boxes CaP, and the transfer thereof into an assembly comprising a container and a, typically recycled, order box CaC.

### Advantages

In summary, the technical solutions according to the present disclosure can make it possible to obtain some or all of the following advantages:
Optimization of the stocking: Loading stocking boxes directly onto containers means it is not necessary to empty the boxes prior to storage, thereby simplifying the procedure and reducing human error.
Logistics efficiency: Transporting storage assemblies to storage spaces optimizes the use of the space and improves the operational efficiency, reducing the processing time required.
Streamlining of the workflow: Picking items directly from storage assemblies in order to place them into order boxes allows a smooth transition of the items from stocking to despatch, reducing the order processing time.
Efficient recycling: Using emptied stocking boxes as order boxes reduces the waste and costs linked to the purchase of new boxes, contributing to a smaller environmental footprint.
Flexibility and adaptability: The system makes it possible to efficiently manage complex orders while at the same time making it easier to assemble combinations of items while still minimizing the associated costs and movements.
Reduction in costs: The automation and optimization of the procedures reduce the operating costs and increase the system's ability to respond to changes to the order.

These advantages contribute to an overall improvement in the efficiency, durability and viability of the automated storage and retrieval system.

### List of Reference Signs

1. Storage and retrieval system,
2. Storage racks,
3. Automated guided carriage,
3a, 3B. First automated guided carriage and second automated guided carriage,
4. Aisle (between the racks),
5a. Manual order fulfilment station,
5b. Robotic order fulfilment station,
6. Input conveyor (storage assemblies each comprising a container and a stocking box)
7. Transfer device (configured to transfer a storage assembly from the input conveyor to an automated guided carriage)
Ai. Items,
BR. Physical barrier,
ES. Storage assemblies,
ER. Entrance of the storage and retrieval system,
So. Exit of the storage and retrieval system,
C. Containers,
CaC. Order box,
CaP. Stocking box,
GPT. Storage structure,
PICK. Picking,
PaP. Stocking workstation,
SMA. Mass storage unit,
Vf. Closure flaps (box),
IN. Input,
OUT. Output.

1. An order fulfilment method implemented in an automated storage and retrieval system comprising:
a storage structure which has storage spaces,
at least one order fulfilment station for fulfilling orders,
containers intended to receive stocking boxes and order boxes, the method comprising stocking the storage structure via items (Ai) originating from stocking boxes each containing at least one item, the method comprising:
/A/ loading each of the stocking boxes onto a container to form storage assemblies,
/B/ transporting the storage assemblies to storage spaces in the storage structure,
/C/ fulfilling orders at said at least one order fulfilment station, including, for all or some of the orders, picking at least one item from at least one of the storage assemblies and placing said at least one item into an order box,
/D/ at least one stocking box being emptied by said picking during one of the order fulfilment operations in /C/ and wherein the stocking box emptied of said at least one item is used as said order box for at least one of the orders in /C/.

2. The order fulfilment method according to claim 1, wherein all or some of the stocking boxes are single-item boxes each comprising one or more structurally identical items.

3. The order fulfilment method according to claim 1, wherein, during the loading operations in /A/, all or some of the stocking boxes loaded onto the containers are closed boxes and wherein said storage assemblies containing the boxes are stored in a closed state in said storage spaces in the storage structure.

4. The order fulfilment method according to claim 1, wherein, during the loading operations in /A/, all or some of the stocking boxes loaded onto the containers are open boxes, and wherein said storage assemblies containing the boxes are stored in an open state in said storage spaces in the storage structure.

5. The order fulfilment method according to claim 1, wherein at least one order is a combination of items which is identical to the contents of the stocking box of said storage assembly, said method comprising
/E/ retrieving said storage assembly from said storage space and transporting said stocking box from said storage assembly directly to the exit of the storage and retrieval system, thereby forming the order box.

6. The order fulfilment method according to claim 1, wherein said loading operations in /A/ also include loading at least one container with a box empty of items to form an empty storage assembly, and transporting said empty storage assembly to one of the storage spaces in the storage structure, and wherein at least one of the order boxes in /C/ is the box, empty of items, of said empty storage assembly that has been retrieved from said storage space.

7. The order fulfilment method according to claim 1, wherein at least one of the orders in /C/ is a combination of items comprising a sub-combination, corresponding to the contents of the stocking box of said storage assembly, from which one or more items might have been removed, and wherein, during step /C/:
said storage assembly is retrieved from said storage space and transported to said at least one order fulfilment station;
at least one second storage assembly comprising one or more items supplementing the combination of items with respect to the sub-combination, is retrieved from one of said storage spaces and transported to the order fulfilment station,
at least one item is transferred from said at least one second storage assembly to said stocking box of said storage assembly containing the sub-combination until the combination is obtained, and then, successively,
transporting said stocking box of said storage assembly containing the combination, in the form of an order box, to an exit of the storage and retrieval system.

8. The order fulfilment method according to claim 1, wherein a box of a storage assembly is withdrawn from the storage structure and emptied according to /D/, and wherein the method comprises:
/DA/ storing the storage assembly comprising the container and the box emptied of items in the storage structure,
and wherein the stocking box used as an order box in /D/ is the box of said storage assembly, emptied of items, that was retrieved from said storage space after storage according to /DA/.

9. The order fulfilment method according to claim 1, wherein the automated storage and retrieval system comprises:
the storage structure containing the storage spaces,
the containers configured to be stored in the storage spaces,
said at least one order fulfilment station, remote from the storage structure, where the order is assembled during the order fulfilment operations according to /C/,
automated means of transport configured to transport storage assemblies between said at least one order fulfilment station and the storage structure and to:
transport, prior to one of the order fulfilment operations in /C/, at least one first storage assembly comprising the container and the stocking box containing said at least one item necessary for one of the orders from said storage space in the storage structure to said at least one order fulfilment station, and
transport, prior to said order fulfilment in /C/, a second storage assembly comprising the container and an order box from said storage space in the storage structure to said at least one order fulfilment station, and wherein, during said order fulfilment in /C/, said method comprises:
transferring said at least one item from said stocking box of said first storage assembly to the order box of the second storage assembly.

10. The order fulfilment method according to claim 9, wherein said automated means of transport are configured to:
transport, after the order fulfilment in /C/, said first storage assembly comprising the container and the stocking box from which said at least one item has been retrieved from the order fulfilment station to one of the storage spaces in the storage structure, and/or
transport said order box to an exit of said storage and retrieval system.

11. The order fulfilment method according to claim 1, including, between one of the order fulfilment operations according to /C/ at the order fulfilment station, on the one hand, and completing said order, on the other hand:
transporting and storing the storage assembly comprising the order box receiving said at least one item of the order in a storage space in the storage structure, prior to transporting the storage assembly containing the order box to an exit of said storage and retrieval system.

12. The order fulfilment method according to claim 1, wherein the automated storage and retrieval system comprises at least one stocking workstation for the loading operations /A/ for loading said stocking boxes onto the containers, thereby forming storage assemblies, said stocking station being remote from the storage structure, and automated means of transport configured to transport the storage assemblies from the re-stocking workstation to the storage spaces in the storage structure.

13. The order fulfilment method according to claim 9, wherein the automated means of transport comprise at least one fleet of automated guided carriages configured to transport:
the storage assemblies each comprising the container and the stocking box and/or
at least one storage assembly comprising the container and the order box comprising said at least one item of the order.

14. The order fulfilment method according to claim 9, wherein the transfer of at least one item during one of the order fulfilment operations in /C/, at the order fulfilment station, is effected while the first storage assembly comprising said stocking box is mounted on a first automated guided carriage, and while the second storage assembly comprising said order box is mounted on a second automated guided carriage, the first carriage and the second carriage being arranged in two adjacent parking spaces facing an operator, or positioned inside the range of action of a robotic arm of the order fulfilment station.

15. The order fulfilment method according to claim 13, comprising an order finalizing step including transporting said order box to an exit of said storage and retrieval system by way of one of the multiple automated guided carriages on which is mounted a storage assembly comprising a container and the order box containing said order and wherein the order box is transported by the automated guided carriage in the direction of the exit, and wherein the method envisages separating the order box comprising the order from said container and then transporting the order box separated from the container to the exit of the storage and retrieval system.

16. The order fulfilment method according to claim 1, wherein said stocking boxes comprise closure flaps configured to close an upper opening of the box, and wherein said storage assemblies each comprising the container and said stocking box are configured to allow the closure flaps to be opened, and wherein the method ensures the opening of the containers of said storage assemblies by way of opening the closure flaps and retention of the folded-down closure flaps against side walls of the box by the addition of a retaining system.

17. The order fulfilment method according to claim 1, wherein the containers comprise a bottom and side rims configured for lateral retention of the stocking box or for retention of the order box.

18. An assembly comprising an automated storage and retrieval system capable of being suitable for implementing the method according to claim 1 and boxes containing one or more items, said storage and retrieval system comprising:
containers,
a storage structure comprising the storage spaces for the containers,
at least one order fulfilment station remote from the storage structure,
automated means of transport configured to transport containers between said at least one order fulfilment station and the storage structure, and automated means of transport configured for storage transport between said at least one order fulfilment station and an exit of the storage and retrieval system comprising a fleet of automated guided carriages,
the automated guided carriages each being equipped with a communication module configured to wirelessly receive and transmit data from and to a remote computer control unit, and wherein said remote control unit ensures management and control of the means of transport, including management of the guide trajectories of the automated guided carriages on a running surface, wherein
a) the boxes are accommodated on the containers, thereby forming storage assemblies,
b) the storage assemblies are stored in the storage spaces in the storage structure, and wherein said control unit has one or more processors, a memory and a set of instructions configured for implementing the order fulfilment method.

19. The assembly according to claim 18, wherein the storage assemblies comprise containers that receive single-item boxes containing multiple structurally identical items.

20. The assembly according to claim 18, wherein the storage spaces in the storage structure accommodate storage assemblies comprising containers that accommodate boxes intended for use as open order boxes empty of items.
